(19) United States
(12) Patent Application Publication
(10) Pub. No.: US 2010/0028758 A1
(43) Pub. Date: Feb. 4, 2010

(54) Suppression of battery thermal runaway

(76) Inventors: Stephen S. Eaves, Charlestown, RI (US); Brandon Dubois, Woonsocket, RI (US); Farshid Bakhtyari, Newton, MA (US)

Correspondence Address: Michael de Angeli, 60 Intrepid Lane, Jamestown, RI, 02835, US

(21) Appl. No.: 12/461,039

(22) Filed: Jul. 30, 2009

Related U.S. Application Data
(60) Provisional application No. 61/129,978, filed on Aug. 4, 2008.

(51) Int. Cl. H01M 10/50

(52) U.S. Cl. 429/50; 429/120

(57) ABSTRACT

Thermal runaway in battery packs is suppressed by inserting packages of hydrated hydrogel at physical interfaces between groups of one or more cells. The hydrogel acts to diffuse and absorb thermal energy released by the cells in the event of a cell failure. During extreme overheating of a battery cell, the water stored by the hydrogel will undergo phase change, that is, begin to vaporize, thus absorbing large amounts of thermal energy and preventing thermal runaway.

### CROSS-REFERENCE TO RELATED APPLICATION

This application claims priority from provisional application Ser. No. 61/129,978, filed Aug. 4, 2008.

### FIELD OF THE INVENTION

This invention relates to battery pack mechanical design. More specifically, the invention relates to suppression of thermal runaway in multiple-cell battery packs through the use of a hydrated hydrogel disposed in thermal contact with cells of the battery to absorb the thermal energy released from an overheated battery cell.

### BACKGROUND OF THE INVENTION

The battery industry is continually expanding to meet the increasing energy needs of the portable equipment, transportation, and communication markets. Lithium-ion is becoming the industry standard battery chemistry due to its high energy density, sealed design and high availability in world markets.

Lithium-ion batteries are produced in a number of variations; the most popular lithium-ion batteries, which have the highest energy density, use a cobalt or nickel-cobalt oxide anode. These batteries have the disadvantage of having the ability to create their own internal supply of oxygen when overheated. More specifically, oxygen is liberated from the oxide material of the anode at elevated temperatures, which can occur due to a variety of causes, such as an internal short circuit, overcharging, or other cause. Since both oxygen and fuel are both internally available to the cells, a fire can start within a single battery cell, and can be difficult to extinguish with conventional methods. In some cases the fire will continue until all the flammable materials in the battery have been exhausted.

The liberated oxygen combined with the flammable electrolyte has resulted in some well-publicized battery fires. One fire of note was the 2006 fire in a laptop computer containing lithium-ion cells manufactured by Sony. This resulted in a recall of battery packs by Sony reportedly costing the company approximately US $429 million. Sony later determined that the fire was caused by metal shavings that were inadvertently encased in the cell during the manufacturing process. A shaving had pierced the battery separator, resulting in an internal short. The short heated the battery separator, causing it to melt, thus compromising the electrical insulation between the positive and negative electrodes. This further short circuit caused severe internal heating of the cell to the point where it vented hot gas and internal cell materials. However, as has been found in many fires involving lithium-ion battery packs, the event did not stop after the venting of the first cell. This is because the defective cell was able to heat an adjoining cell to the point where the adjoining cell also began to vent, and so on; as occurred in the Sony fire, the process can continue until all the cells in the pack have completed the combustion process. This phenomenon is commonly referred to in the industry as “thermal runaway”.

Product liability related to thermal runaway is arguably the most prevalent issue facing manufacturers of lithium-ion battery packs. A solution to this problem would be a significant advance in lithium-ion battery marketability and would be applicable as well to future battery chemistries with a similar challenge. Moreover, conventional battery technology, such as lead-acid, has experienced its own thermal runaway incidents and could possibly benefit from use of a suppression method as in lithium-ion battery packs.

One approach being investigated by Gi-Heon Kim et al at the National Renewable Energy Laboratory (NREL) was presented in NREL document NREL/PR-540-42544. In this approach a “phase-change material” (“PCM”) was used to absorb the energy released from a venting cell, thus preventing thermal runaway. The PCM used was a graphite “sponge” material acting as a carrier and heat diffuser; this graphite sponge was loaded with paraffin wax acting as the phase change material. Thus, when the material was heated by a failed cell, the paraffin wax was melted; the heat required to melt the wax, i.e., change its phase from solid to liquid, was thus effectively absorbed, preventing thermal runaway. The disadvantage of this approach is that the PCM is relatively expensive to manufacture and comprises materials (graphite and paraffin) that are themselves flammable. Further, the graphite/paraffin combination does not provide as much latent heat absorption capacity as would be desired, such that a relatively large quantity of the material must be provided to ensure adequate heat absorption.

Patents relevant to the subject matter of the invention include the following:

U.S. Pat. No. 3,537,907 to Wilson shows disposing individual battery cells in recesses formed in an extruded aluminum heat sink. The heat sink has an electrically insulative outer layer, typically aluminum oxide.

U.S. Pat. No. 5,158,841 to Mennicke et al shows a high-temperature battery (typical operating temperature of 350° C.) in which the spaces between individual cells are filled by a loose material, e.g., quartz sand or granular aluminum oxide, through which a coolant may flow. Heating elements may also be provided. Metal foil bags may be provided as coolant conduits.

Longardner et al U.S. Pat. No. 5,449,571 is directed primarily to providing PCMs in convenient packaging for receiving typical storage batteries for vehicular purposes. Longardner teaches use of the PCMs for control of the temperature of essentially conventional storage batteries; for example, the PCM can absorb excess heat from the battery, e.g., as generated during charging. Longardner also lists a wide range of PCMs at cols. 3-4, including water (at col. 3, line 61), and mentions that gelled PCMs are shown in U.S. Pat. No. 4,585,572 to Lane et al. The Lane patent discusses use of hydrated salts in a gel as PCMs for heat storage purposes, e.g., at col. 3, line 43-col. 4, line 2. Longardner also refers at col. 2 to UK patent application 2 125 156 to Rowbotham, which discloses placing PCMs in sealed bags in battery electrolyte or separator plates, and for other automotive uses. The PCMs can be used for a variety of heating purposes.

U.S. Pat. No. 6,468,689 to Hallaj et al shows in the preferred embodiment using a PCM, typically wax, around the cells of an Li-ion battery pack to absorb heat released during discharge, and also discloses releasing the absorbed heat to heat the cell after discharge, and then discharging the cell at an elevated temperature; this is apparently to take place passively, that is, without specific control elements, since none are shown. The preferred materials undergo phase change at temperatures between about 30 and 60° C.; see col. 4, lines 18-22.

U.S. Pat. No. 6,942,944 to Al-Hallaj et al is a continuation in part of the above and adds the idea of disposing the PCM in a matrix of a “containment lattice member” of, e.g., an aluminum foam.

Maleki et al U.S. Pat. No. 6,797,427 shows surrounding the cells, or groups of cells, of an Li-ion battery with a sleeve of a material that acts as an insulator at low temperatures and as a conductor at higher temperatures, so that the temperature of a given battery can be controlled to remain close to optimum over a wide range of ambient temperatures. The sleeve is to comprise “an aluminum filled thermally conductive phase change material” (claim 3).

U.S. Pat. No. 7,019,490 to Sato shows filling the space between Li-ion cells and a battery case with a heat-conductive adhesive, gel filler, gel sheet, or rubber to promote heat transfer to the outside of the case.

Yahnker et al U.S. Pat. No. 7,270,910 shows improvements in battery packs for cordless power tools. Numerous possibilities are discussed in detail, including providing a mini-refrigerator in the battery pack. The discussion of FIGS. 11-13 at col. 11 of the patent shows several schemes for incorporating PCMs. These may include providing a “gel tube” comprising a plastic sheet containing a gel solution, which may comprise a fluid such as water with “micro phase-change crystals” 25-50 microns in size suspended therein; these may comprise a material such as paraffin wax encapsulated in a thermoplastic. As the battery is heated, heat is transferred to the wax; when the melting temperature of the wax is reached it begins to melt. The temperature of the phase-change material stays constant until the material has completely changed phase, so that the temperature of the battery pack is stabilized during this period. Yahnker et al application 2008/0003491 is a divisional of the '910 patent.

Straubel et al patent application 2007/0218353 discloses a method of inhibiting thermal runaway by potting the lower portions of vertically-extending cells in a heat-conductive solid material which may include a PCM (see paragraph 0020) so that heat released by, for example, a single defective one of the cells is absorbed by all of the others, rather than only by the adjoining cells, so as to limit the temperature rise of the non-defective cells and reduce the chance of thermal runaway.

Thus, although the art discussed teaches the use of hydrated materials and other PCMs in water for absorption of heat, and while Straubel teaches reduction of thermal runaway in multiple-cell battery assemblies by use of PCMs, the art does not appear to suggest that water might itself be useful as a PCM for prevention of battery thermal runaway per se.

### SUMMARY OF THE INVENTION

The present invention provides a novel method for reduction of the probability of thermal runaway and thus fire in battery packs. The components that are required in order to practice the invention are simple, low in cost, and relatively easy to mass manufacture.

According to the present invention, a thermal suppression element comprising a phase change material (PCM) comprising a hydrated hydrogel-forming polymer (or simply “hydrogel”) is disposed in the battery pack in thermal contact with the cells of the pack. The hydrogel used in the preferred environment is a lightly cross linked, partially neutralized polyacrylic acid commonly referred to as “superabsorbent polymer” or SAP. The acrylic or acrylic derivative polymer may be crosslinked by a polyamine crosslinking agent. This material is capable of absorbing a very large quantity of water, which is retained in gel form, having viscosity comparable to a hand cream or gelled medication.

Typically, the hydrated hydrogel of the thermal suppression element will be retained in a pouch or other container adapted to fit closely between the cells of the battery pack. As the water is retained in the gel, it is not dispersed if the container is melted, torn, or ruptured, and therefore retains its heat-absorptive qualities should a cell vent, melt, or rupture. Further, the gel of the thermal suppression element in the pouch conforms to the shape of the cells, rather than pooling at the bottom of the container, as would liquid water. In the event a cell overheats, the water retained in the gel is heated and may be fully or partially vaporized, absorbing the thermal energy released by the cell, and preventing thermal runaway.

Use of water as a PCM has numerous advantages, especially in the context of preventing thermal runaway per se, as opposed to simply serving as a heat-absorptive medium. Firstly, as compared to, for example, waxes or paraffins used in the prior art, water exhibits higher specific heat, such that it is capable of absorbing more heat per unit mass than such materials without phase change. Moreover, the amount of heating required to cause phase change in water, that is, from liquid to gas, is much higher than that required to melt wax; that is, it requires much more heat to cause water to undergo phase change from liquid to gas than to melt wax. Further, water is not flammable; waxes and the like can catch fire, contrary to the goal of preventing thermal runaway. Further, even when prepared as a gel, water is much less expensive than waxes and the like.

### BRIEF DESCRIPTION OF THE DRAWINGS

The invention will be better understood if reference is made to the accompanying drawings, in which:

FIG. 1 shows a perspective view of one embodiment of a thermal suppression element according to the invention, showing a container for the hydrogel material;

FIG. 2 illustrates the manner in which the container of FIG. 1 can be assembled in good thermal contact with the cells of a battery pack;

FIG. 3 shows a view comparable to FIG. 1 of a presently preferred embodiment of the thermal suppression element of the invention, showing a different package for the hydrogel material; and

FIG. 4 shows a view comparable to FIG. 2 of the manner in which a number of the FIG. 3 thermal suppression elements can be assembled in a multi-cell battery pack.

### DESCRIPTION OF THE PREFERRED EMBODIMENTS

As summarized above, according to the invention a thermal suppression element comprises a quantity of water stored as a hydrogel in a pouch in good thermal contact with the cells of a battery pack. If one or more cells overheat, the water will be heated by direct contact with the outer surface of the cell; if the cell ruptures, the water will also be heated by absorption of the heat of the gases released by the cell. If heated sufficiently, the water will at least partially vaporize, thus absorbing an amount of heat per molecule vaporized equal to the latent heat of vaporization. Absorption of heat by the process of change of phase of a material, in this case change of phase of water from liquid to gaseous phase, can be referred to as phase change material (PCM) energy absorption.

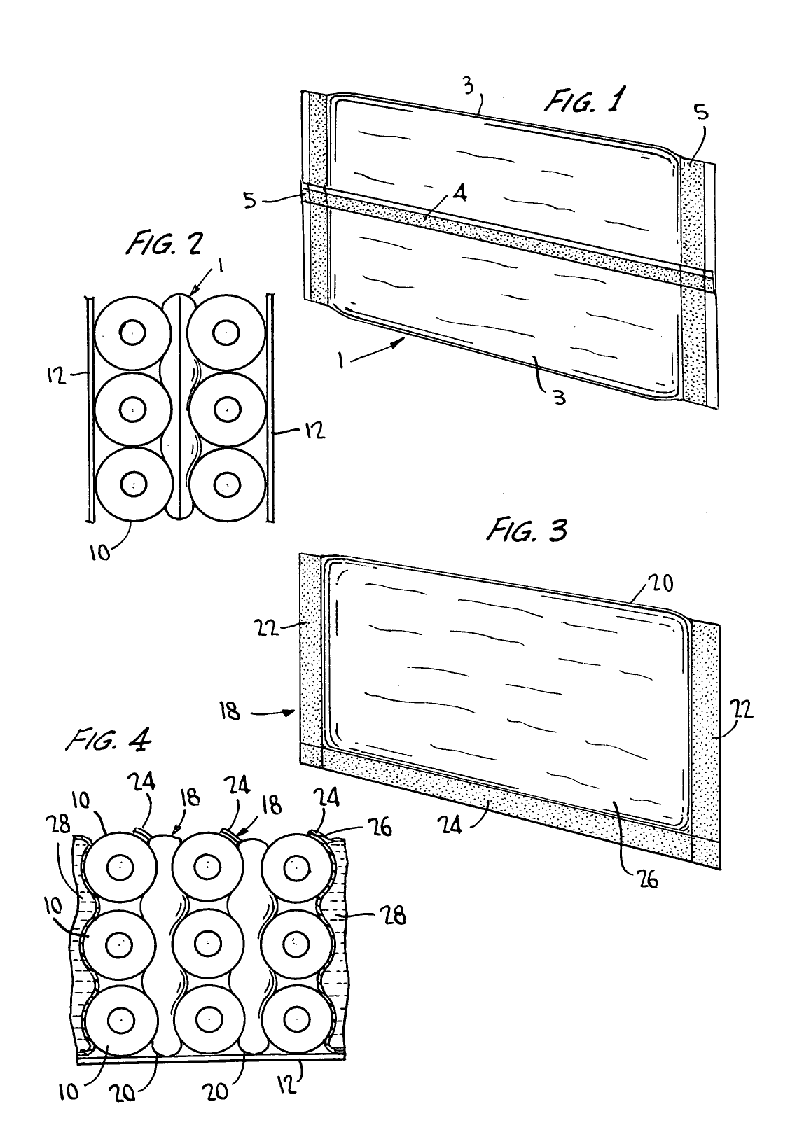

Referring to FIG. 1, in a first preferred embodiment a thermal suppression element 1 comprising a liquid-tight pouch containing a hydrated hydrogel material is constructed by folding and heat-sealing a suitable plastic film. Heat-seal seams are placed in optimum positions to fabricate a package having dimensions suited to the application. Before all seams are closed the pouch is filled with a hydrated hydrogel-forming polymer (hydrogel). The final package is liquid-tight and flexible such that it may conform to the voids at the interface between cell groups.

FIG. 2 shows an endwise view of a portion of a battery pack comprising six individual cylindrical battery cells 10. In this example, the six cells 10 are assembled as two 3-cell groups; typically the three cells of each group will be assembled to circuit boards 12 comprising suitable connection, monitoring, and protection circuitry (not shown). As illustrated, the cell groups are assembled so as to confine the thermal suppression element 1 between the cells of the groups, such that the suppression element is in good thermal contact with each of the cells 10, whereby it can effectively absorb and safely dissipate a substantial portion of any heat released from the cells. As illustrated, passages for cooling air (in normal circumstances) or gases released by a venting cell are provided between the cells 10, circuit boards 12, and thermal suppression elements 1. Should hot gas be released by a defective cell, it is cooled by contact with the hydrated hydrogel in the container, substantially reducing the chance of fire.

As noted above, the flexible film pouch of FIG. 1 has the advantage of readily conforming to the cells when assembled therebetween, but it is also within the invention to contain the hydrogel material in a comparatively rigid container, e.g. a molded plastic container shaped to likewise closely conform to the cells and be in good heat transfer relation therewith. As above, the water contained by the thermal suppression elements of the invention may also be heated by hot gases and other materials released from a cell that ruptures, thus further absorbing heat and reducing the chance of thermal runaway.

FIGS. 3 and 4 show a presently preferred form of the pouch containing the hydrogel material according to the invention. More specifically, the pouch 1 of FIG. 1 is made using the technique known in the art as a “pillow-seal” construction, wherein a sheet of material is first folded at the sides 3 and opposed edges are then heat-bonded to one another to form a longitudinal seam 4. One end seam 5 is then formed; the pouch is then filled, and the opposed end seam 5 closed, sealing the pouch 1. This is a well-established method of forming such a pouch. However, where the end seams 5 intersect the longitudinal seam 4 the seal may be imperfect, leading to leaks, due to the fact that four layers of plastic must be bonded to one another where the central seam 4 intersects the end seams 5.

As shown by FIG. 3, in the presently preferred embodiment the pouch 26 of the thermal suppression element 18 is formed using the “folding table” technique. In this construction, a flat sheet of material is first folded to form a closed edge 20, and the opposed juxtaposed edges are heat sealed at 22. The pouch 26 is then filled with the preferred hydrogel material, and the fourth side sealed at 24.

A third alternative construction of the pouch (not shown) involves the sealing of two separate sheets of film material to one another along four sides; the FIG. 3 construction is preferred for use in the battery pack construction of FIG. 4 because in the third construction the fourth seam (that is, replacing the folded-over, closed edge 20 of the FIG. 3 construction) is difficult to fit into the battery pack while providing adequate thermal contact between the pouch in the vicinity of the fourth seam and the adjoining cells.

FIG. 4 shows the preferred thermal suppression elements 18 of FIG. 3 assembled between a plurality of cells 10 connected to a circuit board 12. Circuitry (not shown) for monitoring and protecting the cells of a complete battery pack may be as shown in commonly-assigned U.S. Pat. No. 7,553,583, and preferred constructional techniques for battery packs that can desirably employ the thermal runaway suppression technique of the invention are shown in commonly-assigned U.S. Pat. No. 7,304,453, both incorporated herein by this reference. However, the utility of the present invention is not limited to battery packs conforming to the disclosures of either of these patents.

As shown in FIG. 4, thermal suppression elements 18 comprising pouches 26 filled with the desired hydrogel material 28, as illustrated by partial cross-sections of two of the pouches 26, are disposed between opposed columns of cells 10, such that the cells 10 are in good thermal contact with the material of the pouch, as illustrated. Conveniently, the seam 24 joining the opposed members of the film so as to close the fourth side of each pouch 18 can be disposed to fit closely around one of the cells 10, as shown, while the folded-over edge 20 fits neatly between adjoining cells 10.

As the cells 10 are in good thermal contact with the pouches 18, if one of the cells overheats, the hydrogel material of the pouch(es) in contact with the cell absorbs the excess heat. To some extent the hydrogel material will transfer some of this heat to other cells, as suggested by, for example, the Straubel et al patent application 2007/0218353 discussed above, and to that extent provision of the pouches filled with hydrogel material according to the invention will tend to equalize the temperature of the various cells contacting a single pouch. Similarly, the thermal mass of the hydrogel will provide heat-absorptive capability, so that if all the cells are heated during charging, their average temperature will be lower than if the hydrogel were not present.

However, as noted above, the main objective of provision of the hydrogel-filled pouches 18 according to the invention is to substantially limit or completely prevent thermal runaway, by providing sufficient thermal mass to absorb the heat released by a cell that is essentially on fire. As mentioned above, use of water as a phase-change material is important in provision of this degree of heat absorption. Water as mentioned has a relatively high specific heat, that is, somewhat more heat (4.18 kJ/(kg.° K)) is required to warm a given amount of water to a given degree than for wax (3.4 kJ/(kg.° K)), for example). Hence a given amount of water can absorb somewhat more heat than an equal mass of wax. More particularly, because according to the invention the water comprised by the hydrogel must be heated from ambient temperature, typically 20° C., to its boiling point of 100° C. before phase change, i.e., vaporization, takes place, far more total heat absorptive capacity is provided than is required to, for example, melt an equivalent amount of wax, which melts at 60° C.

More specifically, the amount of energy required to melt paraffin wax is 195 kJ/jg, while that required to vaporize water is 2260 kJ/kg; accordingly, use of water in lieu of wax provides more than ten times the heat absorptive capability for equal weight of the PCM used before phase change takes place.

Testing of the preferred thermal runaway suppression elements (TSE) according to the invention has been carried out and shows the efficacy of the invention in prevention of thermal runaway. In testing, a 50-watt heater was placed in direct contact with the metal shell of a common 18650 Li-ion cell, and left there for 45 minutes to simulate a dead internal short. Where the TSE was not present the battery was destroyed; where the TSE according to FIG. 3 (and as further described below) was in thermal contact with the cell, the cell remained functional. In the latter case the pouch of the TSE bulged somewhat, indicating partial vaporization, as some of the water evidently underwent phase change, but the pouch retained its structural integrity and did not leak.

The hydrogel used in the preferred environment is a lightly cross linked, partially neutralized polyacrylic acid, commonly referred to as a “superabsorbent polymer” or SAP. A suitable material is marketed as Luquasorb 1161 by BASF Corporation. In this material, an acrylic or acrylic derivative polymer is crosslinked by a polyamine crosslinking agent. Two of the most common types of SAP are sodium and potassium polyacrylate. Both of these types have an extremely high ratio of absorbed water weight to SAP material weight, typically exceeding 200:1. The water content is preferably selected such that the water is fully captured by the SAP material but no more, such that free water does not easily spill out of the pouch of the thermal suppression element if it is inadvertently punctured or torn. Further, because the water is captured by the gel, it does not tend to pool at the lowest part of the pouch but remains dispersed throughout, in contact with each of the cells. Distilled water is preferably used to hydrate the hydrogel, in order to maximize the absorption ratio of water to the SAP material, and to minimize the electrical conductivity of the hydrogel if it escapes its pouch; this reduces the possibility of electrolytic corrosion of battery pack components. To further minimize corrosion of the battery components if the SAP material escapes, a corrosion inhibitor may be included in the SAP hydrogel formulation. Preferably vacuum is applied to the last-sealed seam of the pouch after the hydrogel is placed therein, to eliminate air as much as possible.

In the preferred embodiment, the film of which the pouch of the thermal suppression element of the invention is fabricated may be a laminate including a metal film layer, typically aluminum, with one or more polymer film layers provided on either side of the aluminum film, to allow heat-sealing of the film members to fabricate the pouch. The metal layer provides a vapor barrier to prevent drying out of the hydrogel over long periods of time. A preferred film material is well-known in the art as FR2175-B; this is available from a variety of vendors, and is described (using terminology common in the art) as comprising successive layers of 90 gauge oriented polypropylene, 15 pound polyethylene, 0.000285″ aluminum foil, and 40 pound low density polyethylene film. This material exhibits very low vapor permeability, rendering the thermal runaway suppression elements according to the invention capable of preventing thermal runaway over long periods, and is easily bonded using conventional techniques and equipment.

To improve containment of the hydrogel in the event of a tear in the pouch, the gel may be integrated into a fabric material. The hydrogel-filled fabric material would then be put in a sealed pouch or other container. The fabric helps contain the hydrogel if there is a tear in the pouch. Luquafleece® by BASF Corporation is a suitable fabric material for this purpose. However, as of the filing of this application this alternative is not preferred as the fabric material consumes space better occupied by additional hydrogel material.

As noted above, a number of variations on the container that could be employed are within the scope of the invention. An injection molded or extruded plastic container could be constructed to properly conform to the spaces between cells. The plastic film pouch of the preferred embodiment could be made in various shapes and sizes to accommodate different battery pack geometries.

The number of thermal suppression elements placed in a battery pack according to the invention may vary as required to suppress thermal runaway. For example, a heavily insulated battery pack may have very little inherent capability for dissipation of heat and will require comparatively more thermal suppression material to prevent thermal runaway. Similarly, cells that contain more potential thermal energy will require more suppression material than those containing less.

It should be noted that the thermal suppression elements according to the invention also effectively smooth the peak temperatures reached by battery cells in pulsed-power applications by the provision of sensible heat storage in the SAP hydrogel. In application such as hybrid electric cars, where the batteries are called upon to deliver or absorb substantial amounts of energy at high rates, this may be a useful characteristic. More specifically, the cells in contact with the thermal suppression elements heat the hydrogel during cell power pulses. Under normal circumstances, the degree of heating is below the vaporization point of the hydrogel, and therefore its heat absorption qualities are less than if it were vaporized. Nonetheless, the overall effect of providing the hydrogel and thus adding effective sensible heat storage capacity is to reduce the peak temperature reached by the cells in the battery and thereby increase their service lifetime.

While several preferred embodiments of the invention have been disclosed in detail, the invention is not to be limited thereby, but only by the following claims.

1. A thermal runaway suppression element for interposition between the cells of a multiple-cell battery pack, comprising:
a container conforming to the external surfaces of said cells, such that the container is in good thermal conductive relation with the cells, and
a phase change material consisting essentially of a quantity of water in hydrogel form, disposed in said container,
whereby in the event one of said cells overheats, heat is transferred to the hydrogel, heating the water, such that the water absorbs the heat given off by the overheated cell, and whereby said water can undergo a phase change and be vaporized if sufficiently heated.

2. The thermal runaway suppression element of claim 1, wherein said hydrogel is a lightly cross linked, partially neutralized polyacrylic acid.

3. The thermal runaway suppression element of claim 1, wherein said hydrogel is a superabsorbent polymer.

4. The thermal runaway suppression element of claim 1, wherein said hydrogel is an acrylic or acrylic derivative polymer crosslinked by a polyamine crosslinking agent.

5. The thermal runaway suppression element of claim 1, wherein said hydrogel is a polyacrylate of sodium or potassium.

6. The thermal runaway suppression element of claim 1, wherein said hydrogel is selected from the group consisting of sodium and potassium polyacrylate.

7. The thermal runaway suppression element of claim 1, wherein said container is fabricated of a sheet of material comprising a heat-bondable polymer film.

8. The thermal runaway suppression element of claim 7, wherein said sheet of material further comprises a metallic layer.

9. The thermal runaway suppression element of claim 8, wherein the metal of said metallic layer is aluminum.

10. The thermal runaway suppression element of claim 1, wherein distilled water is used to prepare said hydrogel.

11. A battery pack made up of a plurality of individual cells, comprising circuit components connecting the cells in a desired configuration, and further comprising thermal runaway suppression elements in good thermal contact with each of said cells, wherein each said thermal runaway suppression element comprises:
a container conforming to the external surfaces of one or more of said cells, such that the container is in good thermal conductive relation with the cells, and
a phase change material consisting essentially of a quantity of water in hydrogel form, disposed in said container,
whereby in the event one of said cells overheats, heat is transferred to the hydrogel, heating the water, such that the water absorbs the heat given off by the overheated cell, and whereby said water can undergo a phase change and be vaporized if sufficiently heated.

12. The battery pack of claim 11, wherein said hydrogel is a lightly cross linked, partially neutralized polyacrylic acid.

13. The battery pack of claim 11, wherein said hydrogel is a superabsorbent polymer.

14. The battery pack of claim 11, wherein said hydrogel is an acrylic or acrylic derivative polymer crosslinked by a polyamine crosslinking agent.

15. The battery pack of claim 11, wherein said hydrogel is a polyacrylate of sodium or potassium.

16. The battery pack of claim 11, wherein said hydrogel is selected from the group consisting of sodium and potassium polyacrylate.

17. The battery pack of claim 11, wherein said container is fabricated of a sheet of material comprising a heat-bondable polymer film.

18. The battery pack of claim 17, wherein said sheet of material further comprises a metallic layer.

19. The battery pack of claim 18, wherein the metal of said metallic layer is aluminum.

20. The battery pack of claim 11, wherein distilled water is used to prepare said hydrogel.

21. The battery pack of claim 11, wherein the cells each comprise an internal supply of oxygen and combustible fuel.

22. The battery pack of claim 21, wherein the cells are of Li-ion battery chemistry with at least one metal oxide electrode.

23. A method of suppressing thermal runaway of a battery pack made up of a plurality of individual cells, said battery pack further comprising circuit components connecting the cells in a desired configuration, said method comprising the step of providing thermal runaway suppression elements in good thermal contact with each of said cells, wherein each said thermal runaway suppression element comprises:
a container conforming to the external surfaces of one or more of said cells, such that the container is in good thermal conductive relation with the cells, and
a phase change material consisting essentially of a quantity of water in hydrogel form, disposed in said container,
whereby in the event one of said cells overheats, heat is transferred to the hydrogel, heating the water, such that the water absorbs the heat given off by the overheated cell, and whereby said water can undergo a phase change and be vaporized if sufficiently heated.

24. The method of claim 23, wherein said hydrogel is a lightly cross linked, partially neutralized polyacrylic acid.

25. The method of claim 23, wherein said hydrogel is a superabsorbent polymer.

26. The method of claim 23, wherein said hydrogel is an acrylic or acrylic derivative polymer crosslinked by a polyamine crosslinking agent.

27. The method of claim 23, wherein said hydrogel is a polyacrylate of sodium or potassium.

28. The method of claim 23, wherein said hydrogel is selected from the group consisting of sodium and potassium polyacrylate.

29. The method of claim 23, wherein said container is fabricated of a sheet of material comprising a heat-bondable polymer film.

30. The method of claim 29, wherein said sheet of material further comprises a metallic layer.

31. The method of claim 30, wherein the metal of said metallic layer is aluminum.

32. The method of claim 23, wherein distilled water is used to prepare said hydrogel.
